(19) United States
(12) Patent Application Publication
(10) Pub. No.: US 2020/0248429 A1
(43) Pub. Date: Aug. 6, 2020

(54) Bucket Assembly With A Metering System For A Construction Vehicle

(71) Applicant: Neatoworks, LLC, St. Peters, MO (US)

(72) Inventor: Richard E. Dinkela, III, St. Peters, MO (US)

(73) Assignee: Neatoworks, LLC, St. Peters, MO (US)

(21) Appl. No.: 16/265,396

(22) Filed: Feb. 1, 2019

(51) Int. Cl. E02F 3/407; E02F 3/96; B01F 7/08; B01F 15/02; B28C 5/42; B28C 7/16

(52) U.S. Cl. CPC E02F 3/407; E02F 3/96; B01F 7/08; B01F 2215/0063; B28C 5/4286; B28C 7/167; B01F 2215/0047; B01F 15/0289

(57) ABSTRACT

A bucket assembly for a construction vehicle, having a body with a bottom wall, a rear wall, a first side wall, and a second side wall defining a cavity therein, the first side wall having a discharge outlet. A metering system includes an auger moveably attached to the body along a pivot axis within the cavity. The auger has a motor end and a discharge end. A motor engages with the motor end of the auger and is configured for variable movement of the auger about the pivot axis in a first direction for metered dispensing of a construction material through the discharge outlet, and a second direction for controlled mixing of the construction material within the cavity.

### CROSS-REFERENCE TO RELATED APPLICATIONS

This is a non-provisional application, which derives priority from U.S. patent application Ser. No. 15/896,823, filed Feb. 14, 2018, titled “MECHANIZED AUGER INTEGRATED INTO BUCKET FOR LATERAL DISCHARGE FROM HIGH LIFT OR RELATED VEHICLE,” the entire disclosure of which is incorporated herein by reference.

### BACKGROUND OF THE INVENTION

The subject matter herein relates generally to a bucket assembly for a construction vehicle having a metering system for metered dispensing of construction material.

A variety of heavy equipment is available for use in construction projects to transport, load, dispense, remove, mix, and/or generally move earth and/or construction materials. Heavy duty vehicles include excavators, backhoe loaders, skid steer loaders, compact track loaders, bulldozers, high lift, tractor, dump truck and the like. Many construction vehicles use a variety of removable attachments, assemblies, and/or accessories designed for performing discrete construction tasks. For example, construction vehicles may include a bucket attachment which can be controlled by an operator of the vehicle to load, transport, remove, and/or move earth and construction materials. Other attachments may include, augers, trenchers, grapples, mixers, spreaders, and the like.

Generally, bucket attachments are used to move large quantities of bulk materials by scooping, lifting, transporting, and dumping the materials from one location to another. For example, in the construction of concrete curbing or road paving, a construction vehicle with a bucket attachment may transfer bulk quantities used for the formation of concrete material or asphalt material from a truck or other location to a hopper machine for mixing into a final prepared material to be used in construction. However, conventional bucket attachments cannot retrieve the prepared construction materials from the hopper and/or dispense the prepared construction material to the designated work site with the control and/or with the precision needed, such as for the formation of a curb or pavement. Rather, the mixed concrete or asphalt is manually transferred, such as shoveling, by laborers from the hopper to the work site in the proper metered amount and at the precise location. The manual labor required in this process is time consuming and hazardous to the laborers in the form of fatigue and injuries.

Accordingly, there is a need for a bucket assembly for a vehicle that includes a metering system.

### BRIEF DESCRIPTION OF THE INVENTION

In one embodiment, an electrical device is provided that includes a bucket assembly for a construction vehicle, having a body with a bottom wall, a rear wall, a first side wall, and a second side wall defining a cavity therein, the first side wall having a discharge outlet. A metering system has an auger moveably attached to the body along a pivot axis within the cavity. The auger has a motor end and a discharge end. A motor engages with the motor end of the auger and is configured for variable movement of the auger about the pivot axis in a first direction for metered dispensing of a construction material through the discharge outlet, and a second direction for controlled mixing of the construction material within the cavity.

In another embodiment, a construction vehicle is provided having a detachable body with a bottom wall, a rear wall, a first side wall, and a second side wall forming a cavity therein, the first side wall having a discharge outlet. An auger pivotally attaches to the body within the cavity along a pivot axis, the auger having a motor end and a distal end opposite the motor end. A variable speed motor connects to the motor end of the auger, the motor being configured for rotational movement of the auger about the pivot axis in a first direction for metered dispensing of a construction material through the discharge outlet, and a second direction for controlled mixing of the construction material within the cavity.

In yet another embodiment, a method of metered dispensing of a construction material with a construction vehicle is provided having the steps of coupling a bucket assembly with the construction vehicle, depositing a construction material into the bucket assembly; and metered dispensing of the construction material. The bucket assembly has a body having a bottom wall, a rear wall, a first side wall, and a second side wall forming a cavity therein, the first side wall having a discharge outlet. A metering system has an auger received within the cavity and moveably attached to the body along a pivot axis, the auger having a motor end and a distal end opposite the motor end. A motor is received within the cavity and engages with the motor end of the auger, the motor being configured for variable movement of the auger about the pivot axis in a first direction for metered dispensing of a construction material through the discharge outlet, and a second direction for controlled mixing of the construction material within the cavity.

### BRIEF DESCRIPTION OF THE DRAWINGS

FIG. 1 is a perspective view of a construction vehicle with a bucket assembly in accordance with an embodiment;

FIG. 2 is a perspective view of a bucket assembly in accordance with an embodiment;

FIG. 3 is a front view of the bucket assembly in accordance with an embodiment;

FIG. 4 is a partially exploded partial perspective view of the bucket assembly with a discharge assembly in accordance with an embodiment;

FIG. 5 is a partially exploded partial perspective view of the bucket assembly with an alternate discharge assembly in accordance with an embodiment;

FIG. 6 is a partial perspective view of the bucket assembly with a second alternate discharge assembly in accordance with an embodiment;

FIG. 7 is a rear perspective view of the bucket assembly with a third alternate discharge assembly in accordance with an embodiment;

FIG. 8 is a rear perspective view of an alternate bucket assembly in accordance with an embodiment;

FIG. 9 is a partial rear perspective view of the alternate bucket assembly of FIG. 8 in accordance with an embodiment;

FIG. 10 is a partial side perspective view of the alternate bucket assembly of FIG. 8 in accordance with an embodiment.

### DETAILED DESCRIPTION OF THE INVENTION

Embodiments described herein include construction vehicles that have removable attachments, discharge assemblies, and/or a metering system. For example, the construction vehicle may have a bucket assembly with a metering system and a discharge assembly. The bucket assembly may have a variety of configurations as set forth herein. For example, embodiments may include the metering system having an auger and a variable speed motor configured for mixing and/or metered dispensing of a construction material. Embodiments may also include a discharge assembly having a retractable chute. The metering system and/or discharge assembly may have a variety of configurations as set forth herein. Optionally, the construction material may include any granular material, aggregate material, paving material, soil, sand, mulch, and/or asphalt material or a concrete material.

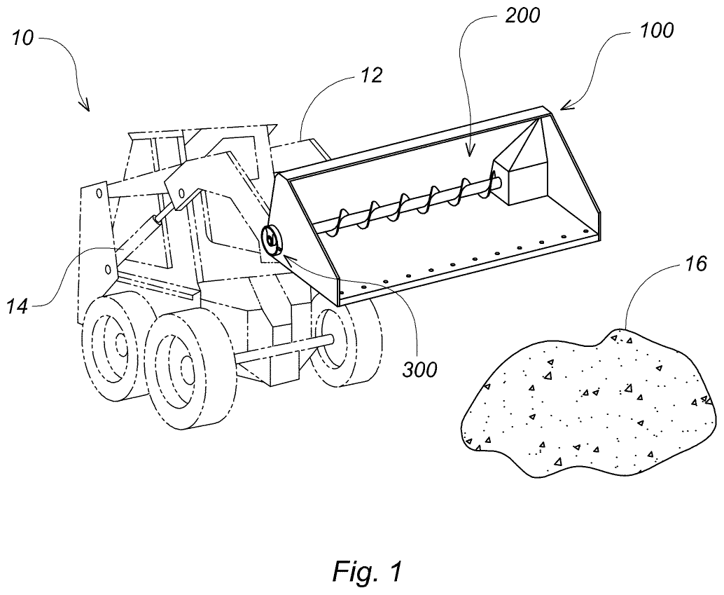

FIG. 1 is a perspective view of a construction vehicle 10 with a bucket assembly 20 in accordance with an embodiment. As shown the construction vehicle 10 is a skid steer loader having a pair of loading arms 12 and a hydraulic system 14 configured for detachable coupling with the bucket assembly 100. In alternate embodiments, the construction vehicle 10 may be an excavator, backhoe loaders, compact track loaders, bulldozers, high lift, tractor, dump truck and the like. An operator may operate the construction vehicle 10 and bucket assembly 100 to scoop and/or receive raw construction materials 16 for conveyance of the construction materials from one location to another location. The bucket assembly 100 includes a metering system 200 configured for mixing the bulk construction materials into prepared construction materials, such as asphalt or concrete. The bucket assembly 100 also includes a discharge assembly 300 configured to direct metered dispensing of the prepared construction material to a designated location.

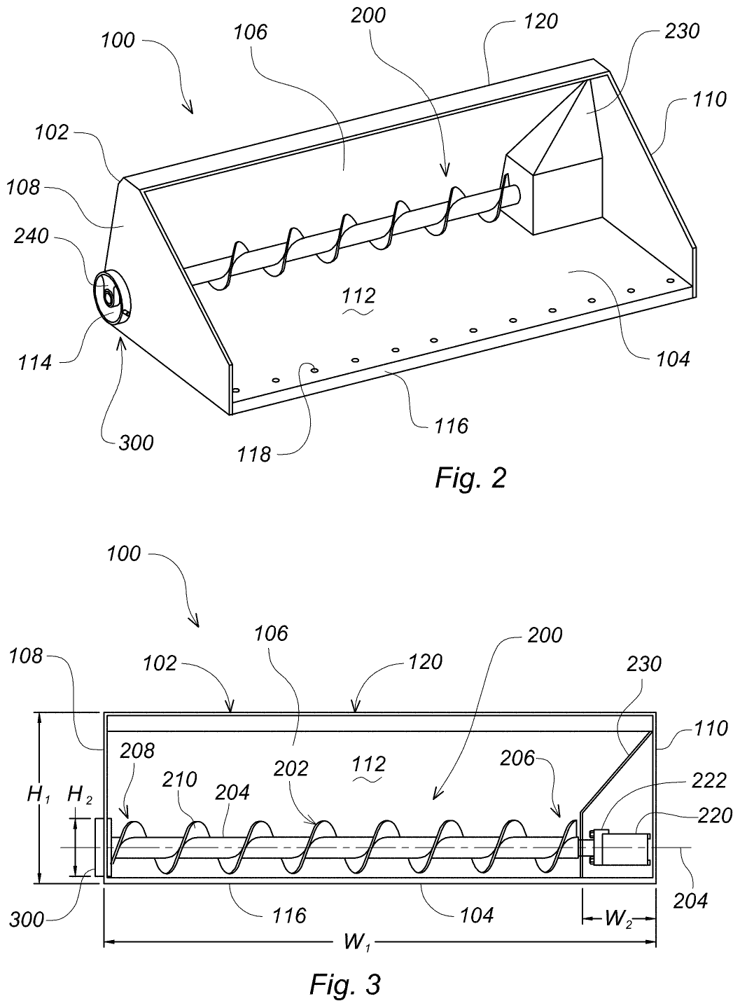

FIG. 2 is a is a perspective view of the bucket assembly 100. FIG. 3 is a front view of the bucket assembly 100 in accordance with an embodiment. The bucket assembly 100 includes a body 102 having a bottom wall 104, a rear wall 106, a first side wall 108, and a second side wall 110 forming a cavity 112 therein. The body 100 has a height H₁ and a width W₁. The first side wall 108 includes a discharge outlet 114 having a height H₂. Optionally, the body 102 may include a hardened component 116 along a front edge of the bottom wall 104. For example, the hardened member 116 may be a strip of hardened steel attached to the front edge, such as by fasteners 118, welding, and the like. In an embodiment, the body 102 may be formed and/or fabricated from metal materials, such as steel, iron, and the like. Optionally, the body 102 may include a reinforcement member 120 extending between the first and second sidewalls 108, 110 proximate a top portion of the rear wall 106, to enhance the structural integrity of the body 102.

The metering system 200 includes an auger 202 moveably attached within the cavity 112 of the body 102 along a pivot axis 204. The auger 202 includes a shaft 204 having a motor end 206 and a distal end 208 opposite the motor end 206. A continuous blade 210 extends along the shaft 204 in a rotational or screw configuration. Optionally, the blade 210 may have other blade configurations. In operation, the configuration of the blade 210 provides for mixing of the construction materials and metering of the construction materials from the cavity 112 to the discharge assembly 300.

The metering system 200 includes a motor 220 received within the cavity 112 proximate the second side wall 110 and engaged with the motor end 206 of the auger 202. The motor 220 may be configured for variable movement of the auger 202 about the pivot axis 204 in a first direction for metered dispensing of a construction material through the discharge outlet 114, and a second direction for controlled mixing of the construction material within the cavity 112. For example, the motor 220 pivots the auger 202 in a clockwise rotation so that the blade 210 biases or conveys the construction material generally lateral direction towards the second side wall 110. Alternatively, the motor 220 pivots the auger 202 in a counter-clockwise rotation that biases or conveys the construction material in a generally lateral direction towards the first side wall 108. In an embodiment the motor 220 may be an electrical motor, a hydraulic motor, or the like.

Optionally, the metering system 200 includes reduction gearing 222 operatively associated with the motor 220 for variable speed control of the auger 202 in the first direction and in the second direction. For example, the motor 220 with reduction gearing 222 may operate at two or more variable speeds to discharge the construction material through the discharge outlet 114 at two or more metered flows. Optionally, the metering system 200 includes a housing 230 having a width W2 proximate the second side wall 110 and surrounding the motor 220 and the reduction gearing 222. The housing 230 is configured to isolate the motor 220 and reduction gearing 220 from contact with the construction material. Optionally, the metering system 200 includes a generally vertical mount 240 attached to the first side wall 108 and extending across the discharge opening 114. The mount 240 is configured to pivotally secure the distal end 208 of the auger 202. The discharge outlet 114 may include a sleeve 242, for reinforcement purposes, and to guide the construction material being discharged, through the force of the auger 202.

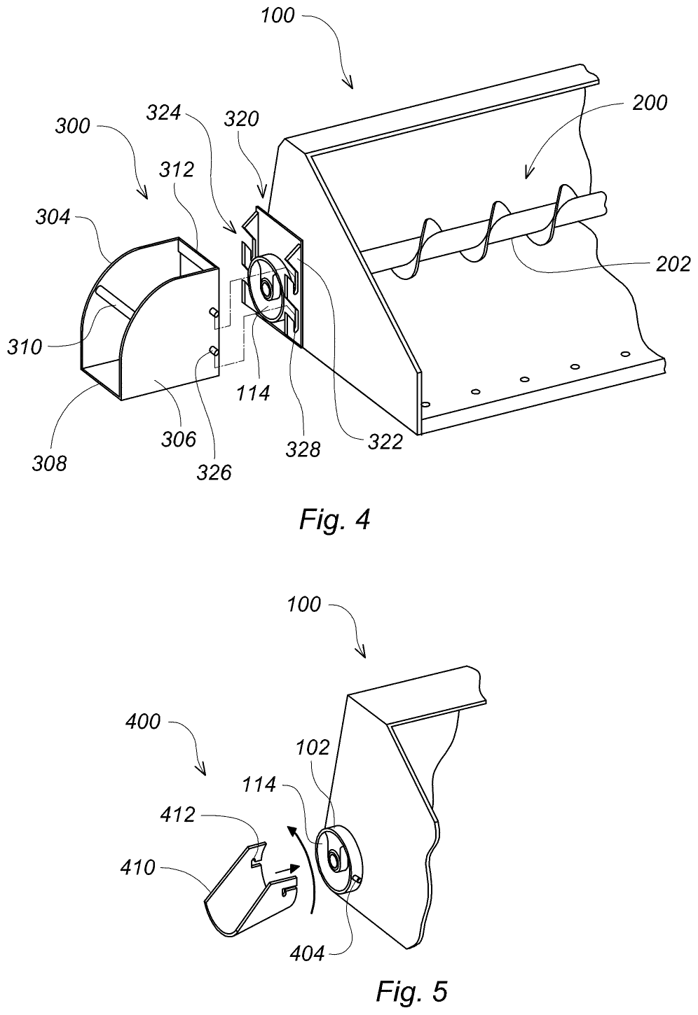

FIG. 4 is a partially exploded partial perspective view of the bucket assembly 100 with a discharge assembly 300 in accordance with an embodiment. The discharge assembly 300 includes a chute 302 having a pair of side walls 304 and 306, a downwardly sloping floor 308, and has reinforcements as at 310 and 312, that enhance the structural integrity the chute 302. The downwardly sloped floor 308 is provided for allowing for the gravity flow of the material, from the bucket assembly 100, during performance of its dispensing function.

Optionally, the chute 302 may include a mount 320 surrounding the discharge outlet 114 of the body 102. The mount 320 includes a pair of side mounts 322, having at least one gripping area 324 on either side, and which can support corresponding extending pins 326 of the chute 302 within their integral slots 328 when suspending the chute 20 in place. The chute 302 can be easily installed, or lifted and removed, as can generally be understood. In any event, as the construction material, is directed by the auger 202 through the discharge outlet 114, the chute, through its downwardly sloped floor 308, precisely directs the construction material to a predetermined location and at a metered amount.

FIG. 5 is a partially exploded partial perspective view of the bucket assembly 100 with an alternate discharge assembly 400 in accordance with an embodiment. The discharge assembly 400 includes a ring component 402 attached to the first side wall 108 and surrounding the discharge outlet 114. The ring component 402 includes tabs 404 extending out from opposing sides. This discharge assembly 400 includes a detachable chute 410 configured to direct the flow of the construction materials discharging from the discharge outlet 114. The chute 410 is generally arcuately shaped and includes slots 412 configured to couple with the tabs 404 of the ring component 402. When installing the arcuate chute 410, it simply can locate the various tabs 404 within the respective slots 412, and then the chute turned a slight dimension counterclockwise, as indicated by the arrow, to lock in position upon the ring component 402.

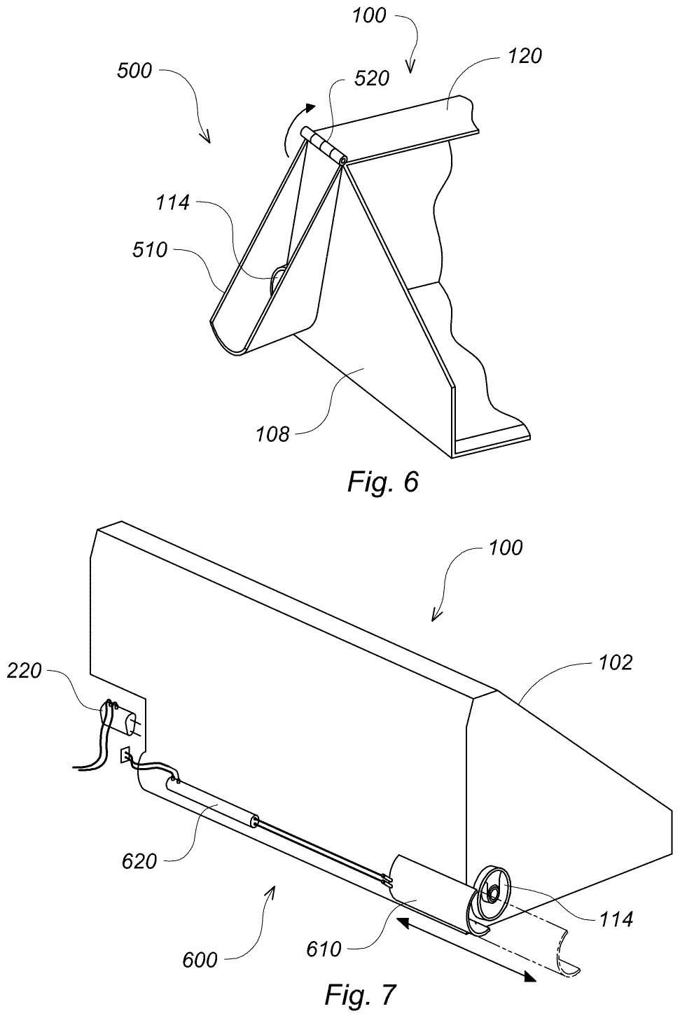

FIG. 6 is a partial perspective view of the bucket assembly with a second alternate discharge assembly 500 in accordance with an embodiment. The discharge assembly 500 includes chute 510 configured to direct the flow of the construction materials discharging from the discharge outlet 114. The chute 510 is generally arcuately shaped and includes a hinge member 520 pivotally attached to an upper portion, such as the reinforcement member 120 of the body 102. In operation, chute 510 may be configured in a discharge position along the first sidewall 120, and in that position, its lower surface, or its arcuate portion 44, will seat around the discharge outlet 114. When not in use, the chute 510 may pivot upwardly about the hinge member 520 to a stored position, it is desired to remove the chute 43 from usage, it can be pivoted upwardly, about its hinge 44, and come to rest upon the top portion of the body 120 (not shown). In this position, the chute will be out of usage, but readily available for application, when necessary.

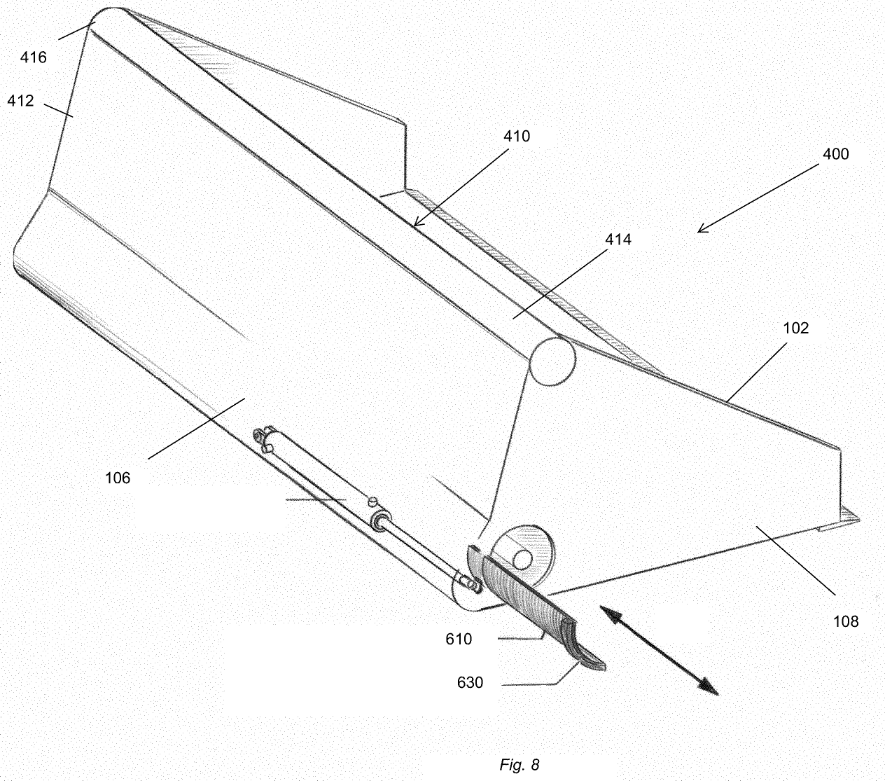

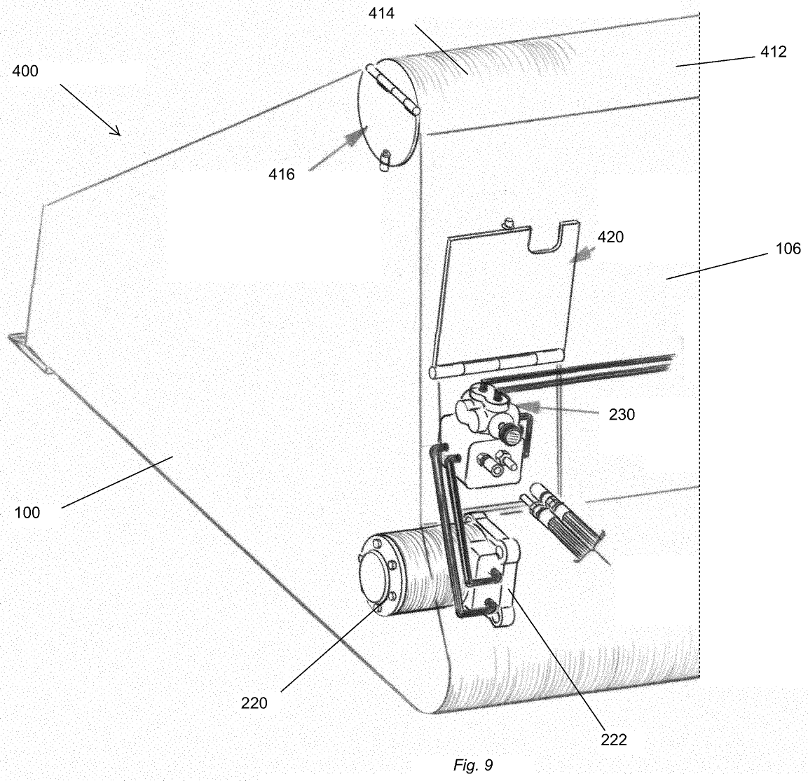

FIG. 7 is a rear perspective view of the bucket assembly 100 with a third alternate discharge assembly 600 in accordance with an embodiment. The discharge assembly 600 includes a retractable chute 610 configured for movement between a retracted position for controlled mixing of the construction material and an extended position for metered dispensing of the construction material. As shown the retractable chute 610 has a generally C-shaped or arcuate cross-section, however, the chute 610 may be any configuration that receives construction material and directs construction material to a precise location. The retractable chute 610 is operatively attached to the motor 220 with an actuator 620. For example, the actuator may be a hydraulic piston, electrical piston, and the like. In operation, as the motor 220 pivots the auger 102 in the first direction (clockwise), the actuator 620 extends the retractable chute 610 through the discharge outlet 114 to a dispensing position for receiving and directing the construction material to a precise location. Alternatively, as the motor 220 pivots the auger 202 in the second direction (counter-clockwise), the actuator 620 retracts the retractable chute 610 through the discharge outlet 114 to a retracted position within the cavity 112 of the body 102. Optionally, the discharge assembly 600 may include a stop mechanism 630 positioned along an end of the retractable chute 610 (FIG. 8). The stop mechanism 630 is configured to prevent overtravel when the actuator 620 retracts the retractable chute 610 through the discharge outlet 114. For example, when retracting, the stop mechanism 630 contacts the first side wall 108 to prevent further retraction.

In operation, the auger 202 can be turned in either direction, either for directing the construction material to the left side of the bucket assembly 100, for dispensing, or the auger 202 may be turned in an opposite direction, for mixing the bulk materials or ingredients within the cavity 112 of bucket assembly 100, before they are dispensed from the bucket assembly 100. All of these can be controlled by the operator, who may initiate the operations of the bucket assembly 100, in the usual manner of their usage and application, and can also actuate the operations of the auger 202, for either turning in a clockwise or counterclockwise direction, depending upon whether mixing or dispensing is to be performed, during the operations of the development. When the construction vehicle 10, moves forward, the body 102 can pick up the various materials, the bucket assembly 100 may be pivoted, for transferring the material to the back of the bucket assembly 100, where the auger 202 can then be used to either achieve mixing, or eventually dispensing, of the material from the bucket assembly 100 in the manner as previously described.

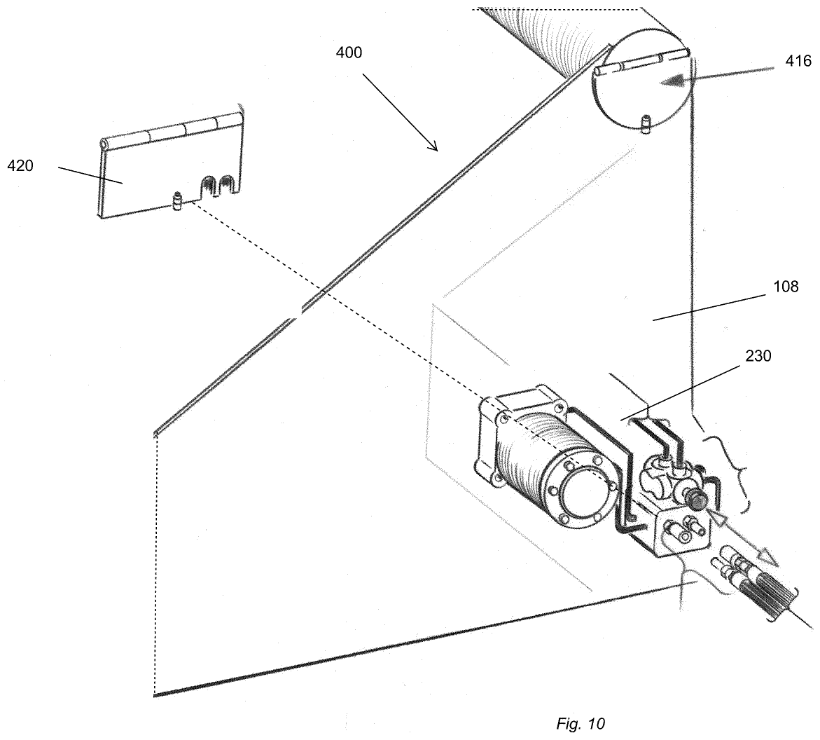

FIG. 8 is a rear perspective view of an alternate bucket assembly 400 in accordance with an embodiment. FIG. 9 is a partial rear perspective view of the alternate bucket assembly 400 of FIG. 8 in accordance with an embodiment. FIG. 10 is a partial side perspective view of the alternate bucket assembly 400 of FIG. 8 in accordance with an embodiment. The embodiment of the bucket assembly 400 shown in FIGS. 8-10 is generally similar to the bucket assembly 100 shown in FIGS. 1-7.

Optionally, the bucket assembly 400 includes a storage compartment 410 located along an upper portion 412 of the body 102. The storage compartment 410 may be configured to receive and store various items related to operation and maintenance of the bucket assembly 400, such as, tubes, tools, accessories, and the like. For example, the storage compartment 410 may be a cylindrical tube 414 that extends along the length of the upper edge of the rear wall 106. The cylindrical tube 414 defines a compartment and a removeable or moveable access door 416 located at and end of the tube. In alternate embodiments, the storage compartment 410 can have other shapes and/or configurations, such as rectangular, oval, triangular, and the like. In addition, the storage compartment 410 may extend along only a partial portion of the body 100. In addition, the storage compartment 410 may be positioned at other positions on the body 100, such as horizontal or vertically along any portion or edge of the bottom wall 104, the rear wall 106, the first side wall 108, and/or the second side wall 110.

The bucket assembly 400 may also include a housing access panel 420 configured provide access to the housing 230 and the internal components therein, such as, the motor 220 and the reduction gearing 222 (FIG. 9). The housing access panel 420 is positioned on the rear wall 106, however, the housing access panel 420 could be located at any suitable location along the body 100 to provide access to the housing 230. For example, the housing access panel 420 can be positioned along the first side wall 108 (FIG. 10).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A bucket assembly for a construction vehicle, comprising:
a body having a bottom wall, a rear wall, a first side wall, and a second side wall forming a cavity therein, the first side wall having a discharge outlet; and
a metering system having an auger received within the cavity and moveably attached to the body along a pivot axis, the auger having a motor end and a distal end opposite the motor end; and a motor received within the cavity and engaged with the motor end of the auger, the motor being configured for variable movement of the auger about the pivot axis in a first direction for metered dispensing of a construction material through the discharge outlet, and a second direction for controlled mixing of the construction material within the cavity.

2. The bucket assembly of claim 1, further comprising a discharge assembly having a receiving end and a discharge end forming a channel therebetween along a length of the discharge assembly, the receiving end being proximate to the distal end of the auger and aligned with the discharge outlet to receive construction material from the discharge outlet, and the discharge end configured to direct metered dispensing of the construction material to a designated location.

3. The bucket assembly of claim 2, the discharge assembly having a retractable chute configured for movement between a retracted position for controlled mixing of the construction material and an extended position for metered dispensing of the construction material.

4. The bucket assembly of claim 1, wherein the motor operates at two or more variable speeds to discharge the construction material through the discharge outlet at two or more metered flows.

5. The bucket assembly of claim 1, further comprising reduction gearing operatively associated with the motor for variable speed control of the auger in the first direction and in the second direction.

6. The bucket assembly of claim 1, further comprising a housing proximate the motor end of the auger and surrounding the motor and the reduction gearing and configured to isolate the motor and reduction gearing from contact with the construction material.

7. The bucket assembly of claim 1, wherein the body includes a mount configured for removable attachment to the construction vehicle.

8. The bucket assembly of claim 1, wherein the construction material is asphalt material.

9. The bucket assembly of claim 1, wherein the construction material is a concrete material.

10. The bucket assembly of claim 1, further comprising a storage compartment along an upper portion of the body.

11. A construction vehicle, comprising:
a detachable body with a bottom wall, a rear wall, a first side wall, and a second side wall forming a cavity therein, the first side wall having a discharge outlet;
an auger pivotally attached to the body within the cavity along a pivot axis, the auger having a motor end and a distal end opposite the motor end; and
a variable speed motor connected to the motor end of the auger, the motor being configured for rotational movement of the auger about the pivot axis in a first direction for metered dispensing of a construction material through the discharge outlet, and a second direction for controlled mixing of the construction material within the cavity.

12. The construction vehicle of claim 11, further comprising a discharge assembly having a receiving end and a discharge end forming a channel therebetween along a length of the discharge assembly, the receiving end being proximate to the distal end of the auger and aligned with the discharge outlet to receive construction material from the discharge outlet, and the discharge end configured to direct metered dispensing of the construction material to a designated location.

13. The construction vehicle of claim 12, the discharge assembly having a retractable chute configured for movement between a retracted position for controlled mixing of the construction material and an extended position for metered dispensing of the construction material.

14. The construction vehicle of claim 11, wherein the motor operates at two or more variable speeds to discharge the construction material through the discharge outlet at two or more metered flows.

15. The construction vehicle of claim 11, further comprising reduction gearing operatively associated with the motor for variable speed control of the auger in the first direction and in the second direction.

16. The construction vehicle of claim 11, further comprising a housing proximate the motor end of the auger and surrounding the motor and the reduction gearing and configured for isolation of the motor and reduction gearing from contact with the construction material.

17. The bucket assembly of claim 11, further comprising a storage compartment along an upper portion of the body.

18. A method of metered dispensing of a construction material with a construction vehicle, comprising the steps of:
coupling a bucket assembly with the construction vehicle;
depositing a construction material into the bucket assembly; and
metered dispensing of the construction material;
wherein the bucket assembly has a body having a bottom wall, a rear wall, a first side wall, and a second side wall forming a cavity therein, the first side wall having a discharge outlet; and a metering system having an auger received within the cavity and moveably attached to the body along a pivot axis, the auger having a motor end and a distal end opposite the motor end; and a motor received within the cavity and engaged with the motor end of the auger, the motor being configured for variable movement of the auger about the pivot axis in a first direction for metered dispensing of a construction material through the discharge outlet, and a second direction for controlled mixing of the construction material within the cavity.

19. The method of metered dispensing of a construction material with a construction vehicle of claim 18, wherein the bucket assembly includes a discharge assembly having a receiving end and a discharge end forming a channel therebetween along a length of the discharge assembly, the receiving end being proximate to the distal end of the auger and aligned with the discharge outlet to receive construction material from the discharge outlet, and the discharge end configured to direct metered dispensing of the construction material to a designated location.

20. The method of metered dispensing of a construction material with a construction vehicle of claim 19, wherein the discharge assembly includes a retractable chute configured for movement between a retracted position for controlled mixing of the construction material and an extended position for metered dispensing of the construction material.
